(19) United States
(12) Patent Application Publication
(10) Pub. No.: US 2009/0215917 A1
(43) Pub. Date: Aug. 27, 2009

(54) ANTIMICROBIAL POLYURETHANE FOAMS

(75) Inventors: Patrick John Trotter, Leeds (GB); Paul William Watt, Steeton (GB); Robert Engel, Carle Place, NY (US); JaimeLee Iolani Rizzo, City Glen Cove, NY (US); Peter Wachtel, Scotch Plains, NJ (US); Jason Paul Knight, North Yorkshire (GB)

Correspondence Address: MORGAN, LEWIS & BOCKIUS LLP, 1701 MARKET STREET, PHILADELPHIA, PA, 19103-2921, US

(73) Assignee: Systagenix Wound Management (US), Inc.

(21) Appl. No.: 12/097,087

(22) PCT Filed: Dec. 5, 2006
(86) PCT No.: PCT/GB2006/004538

§ 371 Date: Nov. 11, 2008

(30) Foreign Application Priority Data
Dec. 15, 2005 (GB) 0525532.8

(51) Int. Cl. C08G 18/00; C08G 18/08

(52) U.S. Cl. 521/157; 521/163; 521/155

(57) ABSTRACT

This invention relates to antimicrobial polyurethane foams and to a method of making antimicrobial polyurethane foams. The invention also relates to the use of such foams in the production of medical devices and pharmaceutical compositions.

### FIELD OF THE INVENTION

This invention relates to antimicrobial polyurethane foams and to a method of making antimicrobial polyurethane foams. The invention also relates to the use of such foams in the production of medical devices and pharmaceutical compositions.

### BACKGROUND OF INVENTION

Polyurethane foams have been proposed for a number of medicinal uses. The foams are prepared by reacting particular diisocyanates or isocyanate-capped prepolymers with suitable chain extending compounds having amine and/or alcohol multiple functionality. Chain terminating compounds such as mono-amines or monohydric alcohols may be included in the reaction mixture. Water may be included in the reaction mixture, since it reacts with isocyanate to liberate carbon dioxide for foaming the mixture.

U.S. Pat. No. 4,339,550 discloses a hydrophilic foam composition which is prepared by the “in situ” reaction of an isocyanate-capped polyether prepolymer having a functionality of from about 2 to about 8, water, and a chemically compatible, essentially non-polar, volatile organic compound. The foam is stated to be capable of achieving a sustained, controlled release of the volatile materials from the foamed structure. Suitable “control release” ingredients include polyols, such as propylene glycol and glycerine.

EP-A-0541391 describes a method of forming a polyurethane foam suitable for use as a wound-contacting layer, the method comprising mixing 1 part by weight of an isocyanate-capped prepolymer having a relatively low isocyanate content of from 0.5 to 1.2 meq NCO groups/g with from 0.4 to 1.0 parts by weight of water in the presence of from 0.05 to 0.4 parts by weight of a C1 to C3 monohydric alcohol, and then drying the product. The use of a relatively small amount of water produces an initial reaction mixture of much higher initial viscosity. Carbon dioxide formed by hydrolysis of isocyanate end groups is therefore trapped, producing a foamed hydrogel. For use as a wound-contact layer, topical medicaments and antiseptics, such as silver sulfadiazine, povidone iodine, chlorhexidine acetate and chlorhexidine gluconate, as well as other therapeutically useful additives such as polypeptide growth factors and enzymes may be incorporated into one or more of the components used to make the foaming mixture.

In developing new antimicrobial materials, it is important to discourage further antibiotic resistance. Ideally, therefore, novel antimicrobial materials will function through non-specific, non-metabolic mechanisms.

For example, polycationic (quaternary ammonium) strings developed in the laboratory of Robert Engel are reported to have antibacterial activity. See Fabian et al, Syn. Lett., 1007 (1997); Strekas et al, Arch. Biochem. and Biophys. 364, 129-131 (1999); and Cohen et al, Heteroat. Chem. II, 546-555 (2000).

WO-A-2005/016972 discloses antimicrobial compounds and processes for the production thereof. More particularly, antimicrobial carbohydrates, peptides and polyesters comprising a polymer moiety linked to a positively charged moiety via a carboxyl group are disclosed.

Suggestions have been made to attach other antibiotic agents, such as gentamycin and penicillin, to the surface of medical devices. See, for example, Keogh et al. U.S. Pat. No. 5,476,509, Ung-Chhun et al, U.S. Pat. No. 6,306,454, Keogh, U.S. Pat. No. 6,033,719, Ragheb et al, U.S. Pat. No. 6,299,604, and Guire, U.S. Pat. No. 5,263,992. See also Kanazawa et al., Polym. Sci., Part A-I 37, 1467-1472 (1993).

There is, clearly, a need for new materials having antimicrobial agents stably attached to their surfaces. Ideally, the antimicrobial agents do not lead to resistance, and are not detached from their surfaces when the material is washed.

### SUMMARY OF INVENTION

In accordance with a first aspect of the present invention, there is provided antimicrobial foamed polyurethane comprising at least one group X;

wherein:
X comprises a group [R—([V^{m+}—R¹—R²] q[Y^{p-}])ₙ];
R is independently selected from divalent hydrocarbon radicals having 1-30 carbon atoms, optionally substituted on the carbon backbone with one or more groups selected from COOH, COO(C₁₋₆ alkyl), COO(C₆₋₂₀ aryl), halo, O(C₁₋₆ alkyl), O(C₆₋₂₀ aryl), O(C₇₋₂₀ alkaryl), O(C₇₋₂₀ aralkyl), ═O, NH₂, NO₂, CN and L;
L is selected from the group consisting of —OH, leaving group and mixtures thereof,
V comprises a positively charged moiety;
m represents an integer of 1-10;
n represents an integer of 1, 2, 3 or 4;
R¹ is independently selected from divalent hydrocarbon radicals having 1-30 carbon atoms;
R² is independently selected from the group consisting of —H, —CH₃, —SH, —F, —Cl, —Br, —I, —OR³, —HN(O)CR⁴, or —O(O)CR⁵, wherein R³, R⁴ and R⁵ are independently selected from the group consisting of —H and monovalent hydrocarbon radicals having 1-30 carbon atoms;
Y represents an anion;
q represents m/p; and,
p represents an integer of 1-10.

The present invention also provides a method for the production of an antimicrobial foamed polyurethane comprising:
(i) mixing a C₁₋₃ alcohol solution comprising a compound having the formula L¹-X wherein:
X comprises a group —[R—([V^{m+}—R¹—R²] q[Y^{p-}])ₙ];
R is independently selected from divalent hydrocarbon radicals having 1-30 carbon atoms, optionally substituted on the carbon backbone with one or more groups selected from COOH, COO(C₁₋₆ alkyl), COO(C₆₋₂₀ aryl), halo, O(C₁₋₆ alkyl), O(C₆₋₂₀ aryl), O(C₇₋₂₀ alkaryl), O(C₇₋₂₀ aralkyl), ═O, NH₂, NO₂, CN and L;
V comprises a positively charged moiety;
m represents an integer of 1-10;
n represents an integer of 1, 2, 3 or 4;
R¹ is independently selected from divalent hydrocarbon radicals having 1-30 carbon atoms;
R² is independently selected from the group consisting of —H, —CH₃, —SH, —F, —Cl, —Br, —I, —OR³, —HN(O)CR⁴, or —O(O)CR⁵, wherein R³, R⁴ and R⁵ are independently selected from the group consisting of —H and monovalent hydrocarbon radicals having 1-30 carbon atoms;
Y represents an anion;
q represents m/p; and,
p represents an integer of 1-10; and,
L¹ is an —OH group or a leaving group;
L is selected from the group consisting of —OH, leaving group and mixtures thereof, with an isocyanate-containing, polyurethane-forming prepolymer; and
(ii) adding an acrylate containing compound and water to the mixture of (i).

### BRIEF DESCRIPTION OF THE FIGURES

FIG. 1 shows the activity of the M3600 and M3667 containing foams against S. aureus and P. aeruginosa.

### DETAILED DESCRIPTION OF THE INVENTION

Preferably, the foamed polyurethane polymer contains 0.0001-100 molar equivalents of group X per urethane bond, more preferably 0.01-50 molar equivalents, more preferably 0.1-0 molar equivalents, more preferably 0.5-5 molar equivalents.

Preferably, the foamed polyurethane polymer is not biodegradable.

The foamed polyurethane polymer may contain other non-polyurethane units or domains. For example, the polyurethane may be a co-polyurethane. Additionally, or alternatively, the foamed polyurethane may be blended, mixed or grafted with other polymers, monomers and/or materials. For example, fillers, curatives, stabilizers, anti-oxidants, pigments, therapeutic agents and the like may be incorporated into the foamed polyurethane of the present invention.

Preferably, the foamed polyurethane polymer comprises 10-10⁷ monomeric units, more preferably 20-1×10⁶, more preferably 30-1×10⁵, more preferably 40-1×10⁴ most preferably greater than 1000 monomeric units.

Preferably, X is covalently or ionically bonded to the foamed polyurethane, more preferably covalently bonded thereto.

Preferably, X is linked to the polyurethane via a carbon atom of the backbone of group R or via a substituent on the backbone of group R, most preferably via a carbon atom of the backbone of group R.

R is preferably selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ aralkylenediyl, C₇₋₃₀ alkarylenediyl and C₅₋₃₀ arylenediyl, any of which is optionally substituted on the carbon backbone with one or more groups selected from COOH, COO(C₁₋₆ alkyl), COO(C₆₋₁₀ aryl), halo, O(C₁₋₆ alkyl), O(C₆₋₁₀ aryl), O(C₇₋₁₀ alkaryl), O(C₇₋₁₀ aralkyl), ═O, NH₂, NO₂, CN and L, wherein L is defined above.

R is more preferably selected from the group consisting of C₁₋₁₆ alkanediyl, C₂₋₁₆ alkenediyl, C₂₋₁₆ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl, any of which is optionally substituted on the carbon backbone with one or more groups selected from COOH, COO(C₁₋₃ alkyl), COO(C₆₋₈ aryl), halo, O(C₁₋₃ alkyl), O(C₆₋₈ aryl), O(C₇₋₁₀ alkaryl), O(C₇₋₁₀ aralkyl) and L, wherein L is defined above.

R is more preferably selected from the group consisting of C₁₋₁₆ alkanediyl, C₂₋₁₆ alkenediyl, C₆₋₁₆ aralkylenediyl and C₆₋₁₆ alkarylenediyl, more preferably a straight chain C₁₋₁₆ alkanediyl, any of which is optionally substituted on the carbon backbone with one or more groups selected from COOH, COO(C₁₋₃ alkyl), COO(C₆₋₈ aryl), halo, O(C₁₋₃ alkyl), O(C₆₋₈ aryl), O(C₇₋₁₀ alkaryl), O(C₇₋₁₀ aralkyl) and L, wherein L is defined above.

Most preferably, R is selected from methylene, 1,2-ethylene, 1,2-propylene, 1,3-propylene, 1,2-butylene, 1,3-butylene, 1,4-butylene, 1,5-pentylene, 1,6-hexylene, 1,8-octylene, 1,10-decylene and 1,12-dodecylene, especially 1,3-propylene, any of which is optionally substituted on the carbon backbone with one or more groups selected from OH and leaving groups.

Where group R is substituted on the backbone, preferably there are 1-10 substituents present, more preferably 1, 2, 3 or 4 substituents present. In a particularly preferred embodiment, R comprises 4 OH or leaving groups or a mixture thereof.

In a preferred embodiment, R is unsubstituted.

Where the foamed polyurethane comprises more that 1 group X, all groups R may be the same or different, preferably the same.

R¹ is preferably selected from the group consisting of C₁₋₃₀ alkanediyl, C₂₋₃₀ alkenediyl, C₂₋₃₀ alkynediyl, C₃₋₃₅ cycloalkanediyl, C₃₋₃₅ cycloalkenediyl, C₅₋₃₅ cycloalkynediyl, C₇₋₃₅ aralkylenediyl, C₇₋₃₅ alkarylenediyl and C₅₋₃₅ arylenediyl.

R¹ is more preferably selected from the group consisting of C₁₋₈ alkanediyl, C₂₋₁₈ alkenediyl, C₂₋₁₈ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl.

R¹ is more preferably selected from the group consisting of C₆₋₁₈ alkanediyl, C₆₋₁₈ alkenediyl, C₆₋₁₈ aralkylenediyl and C₆₋₁₈ alkarylenediyl, more preferably a straight chain C₇₋₁₇ alkanediyl.

R¹ is more preferably selected from the group consisting of a straight chain C₇ alkanediyl, C₈ alkanediyl, C₉ alkanediyl, C₁₀ alkanediyl, C₁₁ alkanediyl, C₁₂ alkanediyl, C₁₃ alkanediyl, C₁₄ alkanediyl, C₁₅ alkanediyl, C₁₆ alkanediyl and C₁₇ alkanediyl.

In a preferred embodiment, the —R¹—R² moiety represents a C₁₋₂ alkyl group or a C₁₋₆ alkyl group. Where a plurality of different X groups is present in the foam of the present invention, a mixture of C₁₂ and C₁₆ alkyl groups may be present.

Most preferably, R¹ is a —(CH₂)₁₅— group or a —(CH₂)₁₁— group.

Where the foamed polyurethane comprises more that 1 group X, all groups R¹ may be the same or different.

In a preferred embodiment, where the foamed polyurethane contains more that 1 group X, all groups R¹ comprise a mixture of hydrocarbon chains. Preferably, at least some of the hydrocarbon chains R¹ in the mixture have 9-17 carbon atoms, preferably 11-15 carbon atoms. In particular, for each polyurethane polymer chain, a plurality of groups X are present which comprise a mixture of R¹ carbon chain lengths selected from C₁₁ to C₁₅ inclusive.

Most preferably, in the antimicrobial foamed polyurethane of the present invention, a —(CH₂)₁₅— group makes up at least 20%, more preferably at least 30%, more preferably at least 40%, more preferably at least 50%, more preferably at least 75%, more preferably at least 90%, more preferably at least 95% of the total R¹ groups. The remaining R″ groups may comprise a mixture of C₁₀ alkanediyl, C₁₁ alkanediyl, C₁₂ alkanediyl, C₁₃ alkanediyl, C₁₄ alkanediyl, C₁₆ alkanediyl, C₁₇ alkanediyl, C₁₈ alkanediyl, C₁₉ alkanediyl and C₂₀ alkanediyl groups.

R² is preferably —H or CH₃, most preferably CH₃.

Y preferably represents an anion, or plurality of anions, which may be the same or different, that balance the charge of positively charged moiety V. The anion may be singly charged, in which case p is 1, doubly charged, in which case p is 2, and so on.

Examples of suitable anions, Y, include, N-hydroxysuccinimidyl, N-hydroxybenzotriazolyl, nitrate, sulfate, bisulfate, phosphate (mono-, bi-, or triphosphate), carbonate, bicarbonate, acetate, tosylates, mesylates, brosylates, sulphonates, halides including chloride, bromide, and iodide, and mixtures thereof. Most preferably, Y is chloride.

Preferably, m is an integer of 1, 2, 3, 4, 5 or 6. Preferably, p is an integer of 1, 2, 3, 4, 5 or 6. Preferably, m is 1, 2 or 3, preferably 1 or 2. Preferably, p is 1, 2 or 3, preferably 1 or 2.

Preferably, the overall charge of the group X is neutral, therefore, for example, when m=2 and p=1, q=2. Alternatively, for example, when m=2 and p=2, q=1. Alternatively, for example, when m=1 and p=1, q=1. Alternatively for example, when m=1 and p=2, q=½. Alternatively for example, when m=3 and p=2, q= 3/2. Alternatively for example, when m=2 and p=3, q=⅔.

A mixture of anions may be employed, having a mixture of charges. Thus, for any particular tri-cationic moiety V (m=3), Y may be, for example, Cl⁻ and CO₃²⁻. Thus, the overall negative charge contributed by the anions, Y, for that V moiety is −3. In this case, q is 2, and p is 1 and 2 for Cl— and CO₃²⁻ respectively.

Where there is more than one anion, Y, in the group X and/or where q=2 or more, Y may be the same or different, preferably the same.

Preferably, n is an integer of 1 or 2, most preferably 1.

R³, R⁴ and R⁵ are preferably independently selected from the group consisting of —H, C₁₋₂₀ alkyl, C₂₋₂₀alkenyl, C₂₋₂₀alkynyl, C₃₋₃₀ cycloalkyl, C₃₋₃₀ cycloalkenyl, C₄₋₃₀ cycloalkynyl, C₇₋₃₀ aralkyl, C₇₋₃₀ alkaryl, C₅₋₃₀ aryl, C₃₋₃₀ heteroaryl, and C₃₋₃₀ heterocyclyl.

R³, R⁴ and R⁵ are more preferably independently selected from the group consisting of —H, C₁₋₁₅ alkyl, C₂₋₁₅ alkenyl, C₂₋₁₅ alkynyl, C₃₋₂₀ cycloalkyl, C₃₋₂₀ cycloalkenyl, C₄₋₂₀ cycloalkynyl, C₇₋₂₀aralkyl, C₇₋₂₀ alkaryl, C₆₋₂₀ aryl, C₃₋₂₀heteroaryl, and C₃₋₂₀ heterocyclyl.

R³, R⁴ and R⁵ are more preferably independently selected from the group consisting of —H, straight chain C₁₋₁₀alkyl, C₂₋₁₀alkenyl and C₆₋₁₂aryl.

Most preferably, R³, R⁴ and R⁵ are independently selected from the group consisting of —H, methyl, ethyl, propyl, butyl, hexyl, cyclohexyl, octyl, nonyl, dodecyl, eicosyl, norbornyl and adamantyl, vinyl, propenyl, cyclohexenyl, benzyl, phenylethyl, phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl, biphenyl, particularly methyl, ethyl, propyl and isopropyl.

The group X preferably bestows the antimicrobial activity on the foams of the present invention.

Group V comprises a positively charged moiety. The positively charged moiety may, for example, be a singly or a doubly charged moiety. In some compounds, V may comprise 3, 4, 5 or 6 positive charges. In a singly charged moiety, m represents 1. In a doubly charged moiety, m represents 2. The singly or doubly charged moiety may, for example, comprise one or two positively charged nitrogen atoms, one or two positively charged phosphorous atoms, one or two positively charged sulfur atoms, or mixtures thereof, preferably nitrogen atoms.

In one embodiment, the positively charged moiety comprises a singly charged quaternary ammonium, quaternary phosphonium or sulfonium group, having the formula ⁺—NR⁶₂—, ⁺—PR⁷₂—, or ⁺—SR⁸—, respectively, wherein R⁶, R⁷ and R⁸ are independently selected from the group consisting of —H and monovalent hydrocarbon radicals.

R⁶, R⁷ and R⁸ are preferably independently selected from the group consisting of —H, C₁₋₂₀ alkyl, C₂₋₂₀ alkenyl, C₂₋₂₀ alkynyl, C₃₋₃₀ cycloalkyl, C₃₋₃₀ cycloalkenyl, C₄₋₃₀ cycloalkynyl, C₇₋₃₀aralkyl, C₇₋₃₀alkaryl, C₅₋₃₀aryl, C₃₋₃₀heteroaryl, and C₃₋₃₀heterocyclyl.

R⁶, R⁷ and R⁸ are more preferably independently selected from the group consisting of —H, C₁₋₁₅ alkyl, C₂₋₁₅ alkenyl, C₂₋₁₅ alkynyl, C₃₋₂₀ cycloalkyl, C₃₋₂₀ cycloalkenyl, C₄₋₂₀ cycloalkynyl, C₇₋₂₀ aralkyl, C₇₋₂₀ alkaryl, C₆₋₂₀ aryl, C₃₋₂₀heteroaryl, and C₃₋₂₀ heterocyclyl.

R⁶, R⁷ and R⁸ are more preferably independently selected from the group consisting of —H, straight chain C₁₋₁₀alkyl, C₂₋₁₀alkenyl and C₆₋₁₂aryl.

Most preferably, R⁶, R⁷ and R⁸ are independently selected from the group consisting of methyl, ethyl, propyl, butyl, hexyl, cyclohexyl, octyl, nonyl, dodecyl, eicosyl, norbornyl and adamantyl, vinyl, propenyl, cyclohexenyl, benzyl, phenylethyl, phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl, biphenyl, particularly methyl, ethyl, propyl and isopropyl.

In the quaternary ammonium ions, the two R⁶ groups on the N atom may be the same, or different. Preferably, both R⁶ groups represent methyl or ethyl.

In the quaternary phosphonium ions, the two R⁷ groups on the P atom may be the same, or different. Preferably, both R⁷ groups represent methyl or ethyl.

In a preferred embodiment, positively charged moiety V comprises two positively charged nitrogen atoms, such as, for example, —⁺NR⁶₂—R⁹—NR⁶₂⁺— or a group (A):

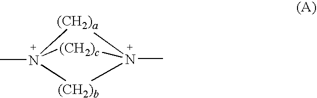

wherein a, b and c independently represent 1-10, preferably, 1-5, more preferably 1-3, most preferably 2. Preferably, a=b=c. In a particularly preferred embodiment, (A) is 1,4-diazoniabicyclo[2.2.2]octane.

In another embodiment, V comprises two positively charged sulfur atoms, such as, for example, —⁺SR⁸—R¹⁰—SR⁸⁺ or a group (B)

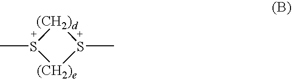

wherein d and e independently represent 1-10, preferably, 1-5, more preferably 1-3, most preferably 2. Preferably, a=b=c. In a particularly preferred embodiment, (B) is 1,4-dithioniumcyclohexane.

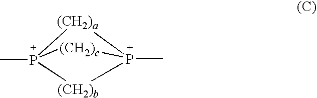

In another embodiment, V comprises two positively charged phosphorus atoms, such as, for example, —⁺PR⁷₂—R^{9′}—PR⁷₂⁺—, or a group (C).

wherein a, b and c independently represent 1-10, preferably, 1-5, more preferably 1-3, most preferably 2. Preferably, a=b=c. In a particularly preferred embodiment, (C) is 1,4-diphosphoniabicyclo[2.2.2] octane.

In these embodiments, R⁶, R⁷ and R⁸ are as defined above, and R⁹, R^{9′} and R¹⁰ are preferably independently selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ aralkylenediyl, C₇₋₃₀ alkarylenediyl and C₅₋₃₀ arylenediyl.

R⁹, R^{9′} and R¹⁰ are more preferably independently selected from the group consisting of C₁₋₁₆ alkanediyl, C₂₋₁₆ alkenediyl, C₂₋₁₆ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl.

R⁹, R^{9′} and R¹⁰ are more preferably independently selected from the group consisting of straight chain C₁₋₆ alkanediyl, C₂₋₁₆ alkenediyl, C₆₋₁₆ aralkylenediyl and C₆₋₁₆ alkarylenediyl.

Most preferably, R⁹, R^{9′} and R¹⁰ are independently selected from methylene, 1,2-ethylene, 1,2-propylene, 1,3-propylene, 1,2-butylene, 1,3-butylene, 1,4-butylene, 1,5-pentylene, 1,6-hexylene, 1,8-octylene, 1,10-decylene and 1,12-dodecylene.

When V comprises —⁺PR⁷₂—R^{9′}—PR⁷₂⁺—, each R⁷ is preferably phenyl and R^{9′} is preferably ethyl, propyl or butyl.

In the group X, preferably n=1 and the —[R—([V^{m+}—R¹—R²] moiety preferably comprises the structure (1):

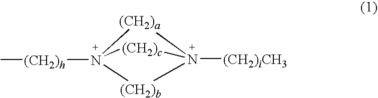

wherein h represents 1-10;
represents 7-17; and
a, b, and c are as defined above.

Preferably, the —(CH₂)ₕ— group is covalently attached directly to the polyurethane polymer.

More preferably, n=1 and the —[R—([V^{m+}—R¹—R²] moiety has the structure (2):

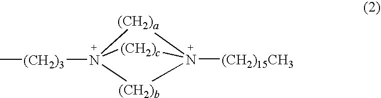

wherein a, b, and c are as defined above.

Preferably, the —(CH₂)₃— group is covalently attached directly to the polyurethane polymer.

More preferably, n=1 and the —[R—([V^{m+}—R¹—R²] moiety has the structure (3):

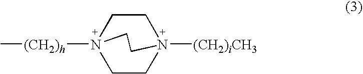

wherein h represents 2-8;
represents 9-17.

Preferably, the —(CH₂)ₕ— group is covalently attached directly to the polyurethane polymer.

Most preferably n=1 and the —[R—([V^{m+}—R′—R²] moiety has the structure (4):

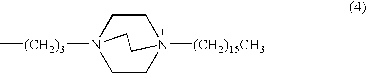

Preferably, the —(CH₂)₃— group is covalently attached directly to the polyurethane polymer.

Preferably, the group (4) comprises at least 20%, more preferably at least 30%, more preferably at least 40%, more preferably at least 50%, more preferably at least 75%, more preferably at least 90%, more preferably at least 95% of the total groups —[R—([V^{m+}—R¹—R² in the antimicrobial foamed polyurethane of the present invention. The remaining —[R—([V^{m+}—R¹—R²] groups which do not have the structure (4) may comprise a mixture of different or the same —[R—([V^{m+}—R¹—R²] q[Y^{p-}])ₙ] groups, wherein the definitions of R, V, m, n, R¹, R², Y, q and p can vary as set out above.

In an alternative embodiment, preferably n=2 and the —[R—([V^{m+}—R¹—R²] moiety has the structure (5):

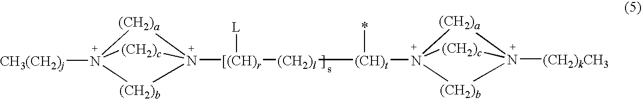

wherein group (5) is covalently attached to the polyurethane polymer via the —(CH)—* group;
j represents 1-17;
k represents 1-17;
r represents 0-10;
l represents 0-10;
represents 0-10;
t represents 1;
L is selected from the group consisting of an OH group or a leaving group, or a mixture thereof, and
a, b, and c are as defined above.

In the illustration of group (5) above, the arrangement of groups within the —[(CHL)ᵣ-(CH₂)ₗ]ₛ—(CH*)ₜ moiety is not intended to denote that the (CHL)ᵣ, (CH₂)₁ or (CH—*)ₜ, groups are present in a particular spacial arrangement. Any one of these moieties can be adjacent or remote from either of the other moieties. Thus, the illustration of group (5) is not intended to denote that the (CHL)ᵣ group is located next to the (CH₂)ₗ group. Nor is the illustration of (5) intended to denote that any particular one of the (CHL)ᵣ, (CH₂)ₗ or (CH—*)ₜ, groups is attached to either of the N+ atoms. All possible arrangements of these groups may occur.

Furthermore, where s is greater than 1, each —[(CHL)ᵣ-(CH₂)ₗ] moiety may be the same or different.

In group (5), j preferably represents 9-17, more preferably 15.

In group (5), k preferably represents 9-17, more preferably 15.

In group (5), r preferably represents 0, 1, 2, 3 or 4, more preferably 3.

In group (5), l preferably represents 0, 1, 2, 3 or 4, more preferably 2.

In group (5), s preferably represents 0, 1, 2, 3, 4, 5 or 6, more preferably 1.

All possible combinations and permutations of r, l and s are envisaged.

In a particularly preferred embodiment where n=2, r=3, l=2 and s=1. In this embodiment, the (CH₂) moieties are each positioned adjacent the N+ atom, and the 3×(CHL) and 1×(CH*) moieties may occupy any of 4 positions in between the (CH₂) moieties.

Preferably, group (5) comprises the structure:

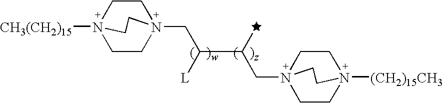

wherein the structure is attached to the polyurethane polymer via the CH^{★} group;
L is an —OH group or a leaving group;
z is 1; and
w is 1, 2 or 3, preferably 3.

The z and w moieties can be adjacent or remote from either of the other z or w moieties. Thus, one or more of the CHL and CH* moieties may be positioned anywhere between the N+-CH₂— moieties.

In the foamed polyurethanes of the present invention, preferably L is a tosylate group or an —OH group, most preferably an —OH group.

Where a plurality of L groups are present, they may be the same or different. Preferably all L groups are —OH.

Throughout this application, unless otherwise indicated, the term “leaving group” generally refers to groups readily displaceable by a nucleophile. Within the context of the present invention, the leaving group is one which results in the linking of group X to the foamed polyurethane by a hydroxyl linkage. Such leaving groups are well known in the art. Examples of such leaving groups include, but are not limited to, N-hydroxysuccinimide, N-hydroxybenzotriazole, acetate, tosylates, mesylates and brosylates.

The method of the present invention essentially comprises a two step process.

In step (i), as defined above, the compound L¹-X is preferably completely dissolved in the C₁₋₃ alcohol before mixing with the pre-polymer takes place.

Preferred compounds having the formula L¹-X have the structures shown below:

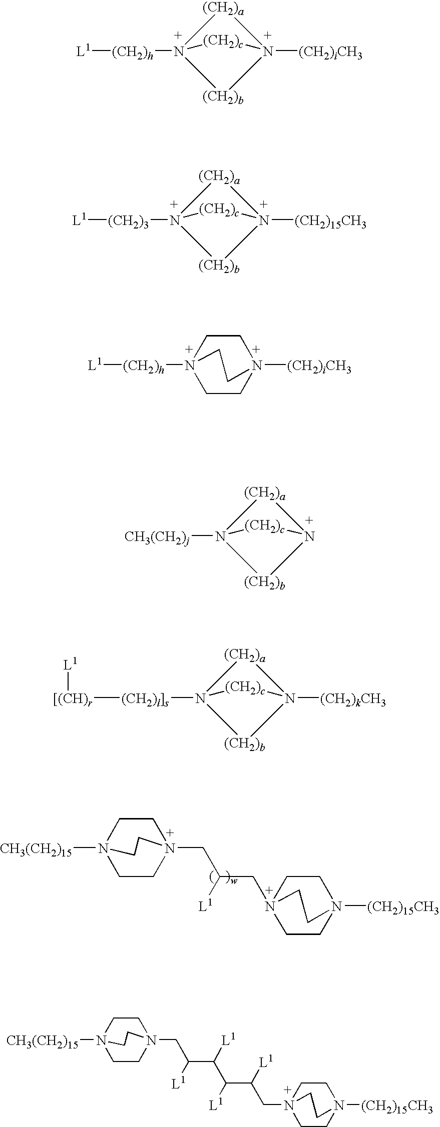

wherein all of a, b, c, h, i, j, k, l, r, s, and L¹ are as defined above.
w is 1, 2, 3 or 4, preferably 4.
r is preferably 2.
l is preferably 4.
s is preferably 1.

In the above illustrations of L¹-X compounds, where a plurality of L¹ groups are present, preferably all but one of the L¹ groups is interchangeable with L groups. Thus, L¹ is being used to denote the group which is displaced in order to form the bond with the polyurethane or its prepolymer. The other L groups are residual or non reacting groups. Thus, in the compound shown at the bottom of the illustrations immediately above, one of the L¹ groups is displaced in the reaction with the polyurethane or its prepolymer, and the other L¹ groups go unreacted.

In the illustrations of L¹-X immediately above, the arrangement of groups within the —[(CHL)ᵣ-(CH₂)ₗ]— moiety is not intended to denote that the (CHL)ᵣ or (CH₂)ₗ groups are present in a particular spacial arrangement. Nor are the illustrations of L¹-X intended to denote that any particular one of the (CHL)ᵣ or (CH₂)ₗ groups is attached to either of the N+ atoms. All possible arrangements of these groups may occur.

In the compounds having the formula L¹-X, preferably L¹ is an OH group or a leaving group. Where a plurality of L¹ groups are present, they may be the same or different. Preferably all L¹ groups are —OH.

In a preferred embodiment of the present invention, the C₁₋₃ alcohol is preferably a mono-ol. Examples of such mono-ols are methanol, ethanol, 1-propanol and 2-propanol. Such alcohols may be employed singly or as a mixture of at least two different alcohols.

The ratio of the compound having the formula L¹-X to the C₁₋₃ alcohol is in the range of about 1:10 to about 2:1 by weight, more preferably about 1:7 to about 1:1, more preferably about 1:6 to about 1:2, most preferably about 1:4 to about 1:3.

The compound L¹-X is preferably added to the C₁₋₃ alcohol in an amount of 20%-50% by weight of the alcohol.

Although the invention comprehends the use as the C₁₋₃ alcohol of any of methanol, ethanol or propanol, the use of methanol is particularly preferred. All three alcohols reduce the rate of reaction between the isocyanate-containing prepolymer and water, but the effect of methanol is more marked. A reduction of the reaction rate is desirable in order to facilitate mixing of the various components and spreading of the reaction mixture into a layer of suitable thickness for curing.

In step (i), the dissolved solution of the compound having the formula L¹-X is preferably added to the prepolymer. If the prepolymer is a liquid, additional solvent is not required. Additional solvents may be incorporated into step (i) of the present invention. Suitable organic solvents include hydrocarbons, ethers, halogenated hydrocarbons, ketones, additional alcohols including polyols, nitrites, amines, esters, carbonates and mixtures thereof.

The solution of the compound having the formula L¹-X in the C₁₋₃ alcohol is preferably added to the prepolymer in the ratio of about 1:20 to about 1:3 by weight, more preferably about 1:10 to about 1:5, more preferably about 1:8 to about 1:4, most preferably about 1:8 to about 1:2.

The alcoholic solution of L¹-X is added to the prepolymer in an amount of 10%-20% by weight of the prepolymer.

Preferably, the prepolymer used in step (i) of the present invention is a diisocyanate terminated oligomer, preferably having a molecular weight of 200 to 5000. The prepolymer is preferably selected from the group selected from diisocyanate terminated polyethylene oxide, diisocyanate terminated polypropylene oxide, diisocyanate terminated polyethylene oxide/polypropylene oxide copolymers, diisocyanate terminated polytetramethylene oxide, diisocyanate terminated polyisobutylene, diisocyanate terminated polyethylene adipate, diisocyanate terminated polycaprolactone and diisocyanate terminated polydimethylsiloxane.

The isocyanate reagent used in the production of the prepolymer may be any suitable isocyanate capping reagent. Preferred isocyanates include aliphatic, alicyclic, aromatic polyisocyanates and combinations of these compounds.

The prepolymer which is used in the method of the invention is preferably an diisocyanate-terminated polyether, such as an ethyleneoxy/propyleneoxy copolymer. Particularly suitable prepolymers are available under the Trade Marks HYPOL® Hydrogel and UREPOL 387.

The mixture of the L¹-X solution and the prepolymer is preferably stirred for between 10 seconds and 10 minutes, preferably between 30 seconds and 5 minutes, more preferably between 45 seconds and 3 minutes, most preferably for about 1 minute. The mixture is preferably stirred with high sheer in a fast stirrer.

The reaction of step (i) is preferably carried out within the temperature range of 0° C.-100° C., preferably 10° C.-60° C., more preferably 15° C.-40° C., more preferably at about ambient temperature (25° C.).

The resultant mixture of the L¹-X solution and the prepolymer is preferably allowed to stand for a period of between 10 seconds and 10 minutes, preferably between 30 seconds and 5 minutes, more preferably between 45 seconds and 3 minutes, most preferably for about 1 minute.

After the mixture of the L¹-X solution and the prepolymer has been left to stand, the mixture of the acrylate and water are added. The resultant foam typically starts to rise within less than 30 seconds, although this depends on the reagents and the process conditions.

Preferably, the water and the acrylate compound are pre-mixed prior to their addition to the solution of L¹-X.

The ratio of the acrylate to water is in the range of about 1:5 to about 1:1 by weight, more preferably about 1:3 to about 1:2.5, more preferably about 1:2.

The reaction of step (ii) is preferably carried out within the temperature range of 0° C.-100° C., preferably 10° C.-60° C., more preferably 15° C.-40° C., more preferably at about ambient temperature (25° C.).

The whole of the mixture of acrylate and water are preferably added to the product of step (i) quickly, i.e., within 1-10 seconds, preferably 2-5 seconds.

In step (ii) of the present invention, the mixture is preferably stirred for between 5 seconds to 2 minutes, more preferably 10 seconds to 1 minute, more preferably for about 20 to 30 seconds.

Once the stirring in step (ii) has ceased, the mixture is preferably either left to stand in the stirring receptacle, or may be poured out into a cast or onto a surface.

Acrylate compounds are preferably selected from the group consisting of (meth)acrylic monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluoyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, 7-(methacryloyloxypropyl)trimethoxysilane, trifluoromethylmethyl (meth)acrylate, 2-trifluoromethylethyl (meth)acrylate, 2-perfluoroethylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate and mixtures thereof. As used herein, “(meth)” is used to denote optional methyl substitution of an acrylate. Thus, “methyl (meth)acrylate” is intended to encompass both methyl methacrylate and methyl acrylate.

A particularly preferred acrylate compound is a compound known by the Trade Mark Primal B-15J.

A curative may be used in step (ii) of the method of the present invention. The curative is suitably selected from conventional organic diamine or polyol materials. Suitable materials are either low melting solids or liquids. Known catalysts may be used in conjunction with the curative.

Suitable curatives can be selected from aliphatic diols, such as 1,4-butanediol (BDO), hydroquinone-bis-hydroxyethyl ether (HQEE), 1,4-cyclohexane dimethanol (CHDM), aliphatic triols, such as trimethylolpropane and aliphatic tetrols. Suitable aromatic diamines include, for example, 4,4′-methylenedianiline (MDA), 2,2′,5-trichloro-4,4′-methylenediamines naphthalene-1,5-diamine, ortho, meta, and para-phenylene diamines, toluene-2,4-diamine, dichlorobenzidine, and diphenylether-4,4′-diamine, including their derivatives and mixtures.

In addition to the C₁₋₃ alcohol, other alcohols, and particularly polyols, may be included in the reaction mixture in step (i) or step (ii) of the present invention to produce a softer foam. For example, a polyol sold by Bayer AG under the Trade Mark Levagel may be used. However, traces of such alcohols are likely to remain in the free form after the foaming reaction, and these traces may be difficult to remove from the foam merely by heating. The use of higher boiling alcohols is therefore preferably avoided if the foam is to be used as a wound contact layer, because of the likelihood that such alcohols will be leached from the foam during use of the dressing. When used as or in wound dressings, the foams of the invention preferably contain less than 1% by weight of water soluble alcohols, and more preferably less than 0.1% by weight. It is particularly preferred that the foams of the invention are essentially free of water soluble alcohols (e.g. less than 0.01% by weight).

The foamed polyurethane may comprise up 100% unreacted L¹-X. Preferably at least 5% of the total L¹-X is covalently attached to the foamed polyurethane, more preferably at least 10%, more preferably at least 20%, more preferably at least 50%, more preferably at least 75%, more preferably at least 90%, more preferably at least 95%.

Additives may be included in the compositions used in either step (i) or step (ii) of the method of the present invention. Such additives may include pigments, stabilizers and other additives.

The pigments are not particularly restricted, and known organic pigments and/or inorganic pigments can be used. Among the suitable organic pigments are, for example, insoluble azo pigments, soluble azo pigments, copper phthalocyanine pigments and quinacridone pigments. The inorganic pigments include, for example, chromates, ferrocyanide compounds, metal oxides, sulfide selenium compounds, metallic salts (e.g., sulfate, silicate, carbonate, phosphate), metallic powder and carbon black. However, if the foamed polyurethane of the present invention is to be used as a wound contact layer, any potentially harmful compounds, such as chromates, should be avoided.

The stabilizers are not particularly restricted, and known antioxidants and/or ultraviolet absorbents may be used. Among the suitable antioxidants are hindered phenols such as 2,6-di-t-butyl-p-cresol and butylhydroxyl anisole; bisphenols such as 2,2′-methylenebis(4-methyl-6-t-butylphenol); and phosphorus compounds such as triphenyl phosphite and diphenyl isodecyl phosphite. Among preferred ultraviolet absorbents are benzophenones such as 2,4-dihydroxybenzophenone and 2-hydroxy-4-methoxybenzophenone; benzotriazoles such as 2-(2′-hydroxy-5′-methylphenyl)benzotriazole; salicylates such as phenyl salicylate; and hindered amines such as bis(2,2,6,6-tetramethyl-4-piperidyl)sebacate.

Foams produced according to the method of the invention typically have a density of at least 0.28 g/cm, and preferably at least 0.30 g/cm. Particularly preferred foams have a density in the range 0.32 to 0.48 g/cm, e.g. about 0.35 g/cm.

The foams produced according to the method of the invention also preferably have an elongation at break of at least 150%, and more preferably at least 300%. Particularly preferred foams according to the invention have an elongation at break in the range from 500 to 2000%.

The foams obtainable by the present invention are preferably free from biopolymers such as polysaccharides or polypeptides. In certain embodiments, the foams obtainable by the present invention consist essentially of polyurethane, the group(s) X and optionally any residual solvents/water.

Depending on the proportions of other additives, the foams produced according to the method of the invention have an absorbency of at least 3 g saline/g, preferably at least 5 g/g, and more preferably from 8 to 20 g/g. Such foams are highly absorbent, yet conformable.

The foams produced according to the method of the invention also have the property of swelling and expanding when water is absorbed. This is particularly advantageous in a wound contact layer, because the swelling of the foam causes it to move inwards towards the wound bed, thus filling the wound cavity. This encourages the wound to heal from the base upwards and outwards, and it discourages epithelialization over the wound surface before the bed has been filled with granulation tissue.

The degree of swelling of the foams produced according to the method of the present invention on complete saturation with an aqueous medium is typically at least 100% (expressed in terms of increase in volume), and preferably at least 200%. Preferred foams swell by 400 to 800%. Despite this high degree of swelling, however, the foams of the invention retain their integrity even after absorption of large quantities of water. Typically, the cells of the foams of the invention have an average diameter in the range 0.1 to 0.6 mm.

It will be appreciated that other components may be added to the reaction mixture in the method of the invention, in order to give desired properties to the product. In particular, it is preferable to include a small proportion (e.g. up to 30% by weight of the wet composition) of a rubber, which may be either natural or synthetic. This has the effect of increasing the cure time for the polyurethane, and increases extensibility, strength and tack. Most importantly, it substantially reduces shrinkage of the gel on drying, and it also improves bubble formation, producing more regular, smaller bubbles. Preferably, the rubber is added in the form of a latex, i.e. a suspension or emulsion of the rubber in an aqueous medium. The latex will generally comprise 40 to 70% solids by weight, e.g. 50 to 60% by weight. If the foam is to be used as a wound contact layer, the rubber must of course be pharmaceutically acceptable. Acrylic-based rubbers are particularly preferred. These are commercially available in the form of latexes, such as PRIMAL N-582 and RHOPLEX N-560, manufactured by the Rohm & Haas company.

Especially suitable for treatment with a dispersion of a medicament in accordance with the present invention are the polyurethane foams available under the name TIELLE® from Johnson & Johnson Medical Ltd.

According to a further aspect of the present invention there is provided a pharmaceutical composition comprising an antimicrobial foamed polyurethane of the present invention in combination with a pharmaceutically acceptable excipient.

According to a further aspect of the present invention there is provided a method of preparing a pharmaceutical composition comprising the step of combining an antimicrobial foamed polyurethane of the present invention with a pharmaceutically acceptable excipient.

The antimicrobial foamed polyurethane of the present invention are preferably used in the manufacture of antimicrobial materials. The antimicrobial foamed polyurethane of the present invention is suitable for manufacturing objects, such as clothing, footware inserts, bandages, sutures, protective gear, containers, and the like.

In a further aspect of the present invention, there is provided a medical device comprising an antimicrobial foamed polyurethane according to the present invention. By “medical device” is meant any device designed to be used while in or on either or both human tissue or fluid. Examples of such devices include, without limitation, wound dressings, stents, implants, catheters, and ophthalmic lenses. In a preferred embodiment, the medical device is a wound dressing.

In a further aspect of the present invention, there is provided a method for manufacturing antimicrobial medical devices comprising incorporating an effective amount of an antimicrobial foamed polyurethane according to the present invention into a medical device.

In a further aspect of the present invention, there is provided a method for manufacturing medical devices comprising contacting at least one surface of a medical device with a coating effective amount of an antimicrobial foamed polyurethane according to the present invention.

In a further aspect of the present invention, there is provided a medicated polyurethane foam obtainable by a method according to the invention.

In a further aspect of the present invention, there is provided a wound dressing comprising a medicated polyurethane foam obtainable by a method according to the invention.

In a further aspect of the present invention, there is provided a kit of parts, comprising:
(i) a C₁₋₃ alcohol as defined herein;
(ii) a compound having the formula L¹-X, as defined herein;
(iii) an isocyanate-containing, polyurethane-forming prepolymer as defined therein; and
(iv) an acrylate containing compound as defined herein.

The kit of parts optionally further comprises water.

Preferably, the kit comprises a first container which contains a mixture of the C₁₋₃ alcohol and the compound having the formula L¹-X.

Preferably, the kit comprises a second container which contains the isocyanate-containing, polyurethane-forming prepolymer, optionally further comprising one or more suitable solvents.

Preferably, the kit comprises a third container which contains the acrylate containing compound.

In one embodiment, the first and second containers may be enclosed together in a fourth container. This embodiment enables the first and second containers to be ruptured, thereby allowing mixing and reaction of the C₁₋₃ alcohol, the compound having the formula L¹-X and the isocyanate-containing, polyurethane-forming prepolymer inside the fourth container. Once sufficient mixing of these components takes place, the acrylate containing compound and water may be added to the fourth container (via a valve, tap or the like) or the fourth container may be ruptured and acrylate containing compound and water mixed with the contents of the fourth container.

Preferably, the fourth container should be capable of facile rupture in order to allow the reaction mixture to expand during foaming. Alternatively, the fourth container may comprise a valve or tap which allows the foam to be ejected therefrom upon expansion (foaming) thereof in a controlled and/or directable manner.

The first and second containers of the kit are preferably capable of facile rupture within the fourth container, without substantially damaging the fourth container.

Alternatively, the first container may be contained within the second container or vice versa. Thus, the container which is enclosed by the other may be ruptured allowing the mixing of the contents thereof with the contents of the other container. In this embodiment, the outer container of the two containers acts in an analogous way to the fourth container, as described above.

Preferably the first, second and fourth containers comprise flexible materials. Preferably the first, second and fourth containers comprise flexible bags.

In one preferred embodiment, the outer container (within which the foaming of the polyurethane takes place) may be shaped in order to allow expansion of the foam therein. The foam can then be moulded to the shape of the container in order to form a predetermined foamed polyurethane shape. The container may then be removed to expose the foamed product.

The first and second containers are capable of effectively separating the respective contents thereof until a predetermined force is applied thereto in order to effect rupture of one or both thereof.

The amounts of the kit components are the same as described above, with respect to the foamed polyurethane of the present invention and the method for the production thereof. The kit may have practical applications in the field of ad hoc wound dressing or wound packing material preparation.

The polyurethane foam of the present invention may be treated with the therapeutic agent before or after the step of forming the foam, i.e., before step (i), during step (i), during step (ii) or after formation of the foamed polyurethane. Preferably, the polyurethane foam may be treated with the therapeutic agent after the step of forming the foam.

The therapeutic agent (medicament) may be antimicrobial drugs or macromolecules such as growth factors, antibacterial agents, antispasmodic agents, or any other active biological bioactive agent, such as adrenergic agents such as ephedrine, desoxyephedrine, phenylephrine, epinephrine and the like, cholinergic agents such as physostigmine, neostigmine and the like, antispasmodic agents such as atropine, methantheline, papaverine and the like, tranquilizers and muscle relaxants such as fluphenazine, chlorpromazine, triflupromazine, mephenesin, meprobamate and the like, antidepressants like amitriptyline, nortriptyline, and the like, antihistamines such as diphenhydramine, dimenhydrinate, tripelennamine, perphenazine, chlorprophenazine, chlorprophenpyradimine and the like, hyptotensive agents such as rauwolfia, reserpine and the like, cardioactive agents such as bendroflumethiazide, flumethiazide, chlorothiazide, aminotrate, propranolol, nadolol, procainamide and the like, angiotensin converting enzyme inhibitors such as captopril and enalapril, bronchodialators such as theophylline, steroids such as testosterone, prednisolone, and the like, antibacterial agents, e.g., sulfonamides such as sulfadiazine, sulfamerazine, sulfamethazine, sulfisoxazole and the like, antimalarials such as chloroquine and the like, antibiotics such as the tetracyclines, nystatin, streptomycin, cephradine and other cephalosporins, penicillin, semi-synthetic penicillins, griseofulvin and the like, sedatives such as chloral hydrate, phenobarbital and other barbiturates, glutethimide, antitubercular agents such as isoniazid and the like, analgesics such as aspirin, acetaminophen, phenylbutazone, propoxyphene, methadone, meperidine and the like, etc. These substances are frequently employed either as the free compound or in a salt form, e.g., acid addition salts, basic salts like alkali metal salts, etc. Simple antimicrobial compounds are preferred, in particular silver salts, povidone iodine, cadexomer iodine, triclosan, polyhexamethylene biguanide (PHMB), and chlorhexidine salts such as chlorhexidine gluconate (CHG).

As mentioned above, the group X bestows the antimicrobial activity on the foams of the present invention. Therefore, the anti-microbial agents referred to immediately above are ‘additional’ antimicrobial agents which may be included to boost the antimicrobial activity of the foam or to prevent/minimise cross-resistance of microbes.

Typically, the therapeutic agent dissolved or suspended in a suitable solvent such as water at a concentration typically of from about 0.01% to about 20% w/v, for example from about 0.1% to about 10 wt %, will be contacted with the polyurethane foam by immersion. Suitable temperatures for the immersion are from about 0° C. to about 80° C., for example from about 5° C. to about 50° C. The foam is then removed from the solvent. It may be dried in air or other atmosphere, for example at a temperature of from about 20° C. to about 80° C., or it may be freeze-dried. Preferably, the resulting material is sterilized, for example by gamma-irradiation.

The loading of the foam with the therapeutic agent may readily be determined based upon the weight of the solution taken up by the foam. Suitable loadings for antimicrobials such as chlorhexidine salts, povidone iodine or triclosan are from about 0.1 wt % to about 10 wt. %, for example from about 0.5 wt % to about 5 wt %, based on the dry weight of the foam. In a preferred method for forming the loaded polyurethane foam, the therapeutic agent is dissolved in water at a suitable concentration, typically about 1-10% by weight, and the sponge is immersed therein for a period of about 10 to about 300 minutes at ambient temperature (about 20-25° C.).

Suitably, the medicated polyurethane foam in the dressing is in the form of a sheet, for example of area about 1 cm² to about 200 cm², and suitably of uncompressed thickness about 1 mm to about 5 mm. The medicated polyurethane foam may preferably form the wound contacting layer of the wound dressing, but it could be any layer that is capable of fluid exchange with the wound surface.

Preferably, the wound dressing of the invention further comprises an absorbent layer and/or a backing layer. As will be evident from the above, the absorbent layer may, for example, be positioned intermediate the medicated polyurethane foam wound contacting layer from the backing layer. The area of the optional absorbent layer is typically in the range of from 1 cm² to 200 cm², more preferably from 4 cm² to 100 cm².

The optional absorbent layer may comprise any of the materials conventionally used for absorbing wound fluids, serum or blood in the wound healing art, including gauzes, nonwoven fabrics, superabsorbents, hydrogels and mixtures thereof. For example, the absorbent layer may be a nonwoven fibrous web, for example a carded web of viscose staple fibers. The basis weight of the absorbent layer may be in the range of 50-500 g/m², such as 100-400 g/m². The uncompressed thickness of the absorbent layer may be in the range of from 0.5 mm to 10 mm, such as 1 mm to 4 mm. The free (uncompressed) liquid absorbency measured for physiological saline may be in the range of 5 to 30 g/g at 25°. The viscose web may incorporate superabsorbent fibers, for example the product known as OASIS®.

Preferably, the wound dressing further comprises a backing layer covering the medicated polyurethane foam and the optional absorbent layer on the side opposite the wound-facing side of the dressing. The backing layer preferably provides a barrier to passage of microorganisms through the dressing and further preferably blocks the escape of wound fluid from the dressing. The backing layer may extend beyond at least one edge of the medicated polyurethane foam and optional absorbent layer to provide an adhesive-coated margin adjacent to the said edge for adhering the dressing to a surface, such as to the skin of a patient adjacent to the wound being treated. An adhesive-coated margin may extend around all sides of the medicated polyurethane foam and optional absorbent layer, so that the dressing is a so-called island dressing. However, it is not necessary for there to be any adhesive-coated margin.

Preferably, the backing layer is substantially liquid-impermeable. The backing sheet is preferably semipermeable. That is to say, the backing sheet is preferably permeable to water vapour, but not permeable to liquid water or wound exudate. Preferably, the backing sheet is also microorganism-impermeable. Suitable continuous conformable backing sheets will preferably have a moisture vapor transmission rate (MVTR) of the backing sheet alone of 300 to 5000 g/m²/24 hrs, preferably 500 to 2000 g/m²/24 hrs at 37.5° C. at 100% to 10% relative humidity difference. The backing sheet thickness is preferably in the range of 10 to 1000 micrometers, more preferably 100 to 500 micrometers.

Suitable polymers for forming the backing sheet include polyurethanes and poly alkoxyalkyl acrylates and methacrylates such as those disclosed in GB-A-1280631. Preferably, the backing sheet comprises a continuous layer of a high density blocked polyurethane foam that is predominantly closed-cell. A suitable backing sheet material is the polyurethane film available under the ESTANE® 5714F.

The adhesive layer (where present) should be moisture vapor transmitting and/or patterned to allow passage of water vapor therethrough. The adhesive layer is preferably a continuous moisture vapor transmitting, pressure-sensitive adhesive layer of the type conventionally used for island-type wound dressings, for example, a pressure sensitive adhesive based on acrylate ester copolymers, polyvinyl ethyl ether and polyurethane as described for example in GB-A-1280631. The basis weight of the adhesive layer is preferably 20 to 250 g/m², and more preferably 50 to 150 g/m². Polyurethane-based pressure sensitive adhesives are preferred.

Preferably, the adhesive layer extends outwardly from the absorbent layer and the medicated polyurethane foam to form an adhesive-coated margin on the backing sheet around the absorbent layer as in a conventional island dressing.

Preferably, the wound dressing according to the present invention is sterile and packaged in a microorganism-impermeable container.

In relation to medical devices, “antimicrobial” is preferably meant that bacterial adherence to the device surface is reduced in comparison to the uncoated surface, by about 5% or more, preferably 10% or more, preferably 30% or more.

The terms “comprising” and “comprises” means “including” as well as “consisting” e.g. a composition “comprising” X may consist exclusively of X or may include something additional e.g. X+Y.

The word “substantially” does not exclude “completely” e.g. a composition which is “substantially free” from Y may be completely free from Y. Where necessary, the word “substantially” may be omitted from the definition of the invention.

“Optional” or “optionally” means that the subsequently described event of circumstances may or may not occur, and that the description includes instances where said event or circumstance occurs and instances in which it does not.

“May” means that the subsequently described event of circumstances may or may not occur, and that the description includes instances where said event or circumstance occurs and instances in which it does not.

As used herein, the term “substituted” is contemplated to include all permissible substituents of organic compounds. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

As used herein, the term “monovalent hydrocarbon radicals” refers to any straight chain, branched, cyclic, acyclic, heterocylic, saturated or unsaturated radical, which contains a carbon backbone comprising one or more hydrogen atoms. The term “monovalent hydrocarbon radical” is intended to encompass the terms “alkyl”, “alkenyl”, “alkynyl”, “cycloalkyl”, “cycloalkenyl”, “cycloalkynyl”, “alkaryl”, “aralkyl”, “aryl”, “heteroaryl” and “heterocyclyl” as defined below.

As used herein, the term “alkyl” refers to a straight or branched saturated monovalent hydrocarbon radical, having the number of carbon atoms as indicated. By way of nonlimiting example, suitable alkyl groups include methyl, ethyl, propyl, butyl, pentyl, hexyl, octyl, nonyl, dodecyl and eicosyl.

As used herein, the term “alkenyl” refers to a straight or branched unsaturated monovalent hydrocarbon radical, having the number of carbon atoms as indicated, and the distinguishing feature of a carbon-carbon double bond. By way of nonlimiting example, suitable alkenyl groups include ethenyl, propenyl, butenyl, penentyl, hexenyl, octenyl, nonenyl, dodecenyl and eicosenyl, wherein the double bond may be located any where in the carbon backbone.

As used herein, the term “alkynyl” refers to a straight or branched unsaturated monovalent hydrocarbon radical, having the number of carbon atoms as indicated, and the distinguishing feature of a carbon-carbon triple bond. By way of nonlimiting example, suitable alkynyl groups include ethynyl, propynyl, butynyl, penynyl, hexynyl, octynyl, nonynyl, dodycenyl and eicosynyl, wherein the triple bond may be located any where in the carbon backbone.

As used herein, the term “cycloalkyl” refers to a cyclic saturated monovalent hydrocarbon radical, having the number of carbon atoms as indicated. By way of nonlimiting example, suitable cycloalkyl groups include cyclopropyl, cyclobutyl, cyclopentyl, cyclohexyl, methylcyclohexyl, dimethylcyclohexyl, trimethylcyclohexyl, cycloheptyl, cyclooctyl, cyclononyl, cyclododecyl, spiroundecyl, bicyclooctyl and adamantyl.

As used herein, the terms “cycloalkenyl” and “cycloalkynyl” refer to cyclic unsaturated monovalent hydrocarbon radicals. A “cycloalkenyl” is characterized by a carbon-carbon double bond and a “cycloalkynyl” is characterized by a carbon-carbon triple bond. Such groups have the number of carbon atoms as indicated. By way of nonlimiting example, suitable cycloalkenyl groups include cyclohexene and cyclohexadiene.

As used herein, the term “aryl” refers to monovalent unsaturated aromatic carbocyclic radical having one, two, three, four, five or six rings, preferably one, two or three rings, which may be fused or bicyclic. Preferably, the term “aryl” refers to an aromatic monocyclic ring containing 6 carbon atoms, which may be substituted on the ring with 1, 2, 3, 4 or 5 substituents as defined herein; an aromatic bicyclic or fused ring system containing 7, 8, 9 or 10 carbon atoms, which may be substituted on the ring with 1, 2, 3, 4, 5, 6, 7, 8 or 9 substituents as defined herein; or an aromatic tricyclic ring system containing 10, 11, 12, 13 or 14 carbon atoms, which may be substituted on the ring with 1, 2, 3, 4, 5, 6, 7, 8, 9, 10, 11, 12 or 13 substituents as defined herein. By way of nonlimiting example, suitable aryl groups include phenyl, biphenyl, binaphthyl, indanyl, phenanthryl, fluoryl, flourenyl, stilbyl, benzphenanthryl, acenaphthyl, azulenyl, phenylnaphthyl, benzfluoryl, tetrahydronaphthyl, perylenyl, picenyl, chrysyl, pyrenyl, tolyl, chlorophenyl, dichlorophenyl, trichlorophenyl, methoxyphenyl, dimethoxyphenyl, trimethoxyphenyl, fluorophenyl, difluorophenyl, trifluorophenyl, nitrophenyl, dinitrophenyl, trinitrophenyl, aminophenyl, diaminophenyl, triaminophenyl, cyanophenyl, chloromethylphenyl, tolylphenyl, xylylphenyl, chloroethylphenyl, trichloromethylphenyl, dihydroindenyl, benzocycloheptyl and trifluoromethylphenyl.

The term “heteroaryl” refers to a monovalent unsaturated aromatic heterocyclic radical having one, two, three, four, five or six rings, preferably one, two or three rings, which may be fused or bicyclic. Preferably, “heteroaryl” refers to an aromatic monocyclic ring system containing five members of which at least one member is a N, O or S atom and which optionally contains one, two or three additional N atoms, an aromatic monocyclic ring having six members of which one, two or three members are a N atom, an aromatic bicyclic or fused ring having nine members of which at least one member is a N, O or S atom and which optionally contains one, two or three additional N atoms or an aromatic bicyclic ring having ten members of which one, two or three members are a N atom. By way of nonlimiting example, suitable heteroaryl groups include furanyl, pyranyl, pyridyl, phthalimido, thiophenyl, pyrrolyl, imidazolyl, pyrazolyl, thiazolyl, isothiazolyl, oxazolyl, oxadiazolyl, pyronyl, pyrazinyl, tetrazolyl, thionaphthyl, benzofuranyl, isobenzofuryl, indolyl, oxyindolyl, isoindolyl, indazolyl, indolinyl, azaindolyl, isoindazolyl, benzopyranyl, coumarinyl, isocoumarinyl, quinolyl, isoquinolyl, cinnolinyl, quinazolinyl, pyridopyridyl, benzoxazinyl, quinoxadinyl, chromenyl, chromanyl, isochromanyl, carbolinyl, thiazolyl, isoxazolyl, isoxazolonyl, isothiazolyl, triazolyl, oxadiazolyl, thiadiazolyl, benzodioxepinyl and pyridazyl.

The term “heterocyclyl” refers to a saturated or partially unsaturated ring having three members of which at least one member is a N, O or S atom and which optionally contains one additional O atom or additional N atom; a saturated or partially unsaturated ring having four members of which at least one member is a N, O or S atom and which optionally contains one additional O atom or one or two additional N atoms; a saturated or partially unsaturated ring having five members of which at least one member is a N, O or S atom and which optionally contains one additional O atom or one, two or three additional N atoms; a saturated or partially unsaturated ring having six members of which one, two or three members are an N, O or S atom and which optionally contains one additional O atom or one, two or three additional N atoms; a saturated or partially unsaturated ring having seven members of which one, two or three members are an N, O or S atom and which optionally contains one additional O atom or one, two or three additional N atoms; a saturated or partially unsaturated ring having eight members of which one, two or three members are an N, O or S atom and which optionally contains one additional O atom or one, two or three additional N atoms; a saturated or partially unsaturated bicyclic ring having nine members of which at least one member is a N, O or S atom and which optionally contains one, two or three additional N atoms; or a saturated or partially unsaturated bicyclic ring having ten members of which one, two or three members are an N, O or S atom and which optionally contains one additional O atom or one, two or three additional N atoms. Preferably, heterocycles comprising peroxide groups are excluded from the definition of heterocyclyl. By way of nonlimiting example, suitable heterocyclyl groups include pyrrolinyl, pyrrolidinyl, dioxolanyl, tetrahydrofuranyl, morpholinyl, imidazolinyl, imidazolidinyl, pyrazolidinyl, piperidinyl, dihydropyranyl, tetrahydropyranyl, thiopyranyl, tetrahydrothiopyranyl and piperazinyl.

As used herein, the term “alkaryl” refers to an aryl group with an alkyl substituent. Binding is through the aryl group. Such groups have the number of carbon atoms as indicated. The alkyl and aryl moieties of such a group may be substituted as defined herein, with regard to the definitions of alkyl and aryl. The alkyl moiety may be straight or branched. Particularly preferred examples of alkaryl include tolyl, xylyl, butylphenyl, mesityl, ethyltolyl, methylindanyl, methylnaphthyl, methyltetrahydronaphthyl, ethylnaphthyl, dimethylnaphthyl, propylnaphthyl, butylnaphthyl, methylfluoryl and methylchrysyl.

As used herein, the term “aralkyl” refers to an alkyl group with an aryl substituent. Binding is through the alkyl group. Such groups have the number of carbon atoms as indicated. The aryl and alkyl moieties of such a group may be substituted as defined herein, with regard to the definitions of aryl and alkyl. The alkyl moiety may be straight or branched. Particularly preferred examples of aralkyl include benzyl, methylbenzyl, ethylbenzyl, dimethylbenzyl, diethylbenzyl, methylethylbenzyl, methoxybenzyl, chlorobenzyl, dichlorobenzyl, trichlorobenzyl, phenethyl, phenylpropyl, diphenylpropyl, phenylbutyl, biphenylmethyl, fluorobenzyl, difluorobenzyl, trifluorobenzyl, phenyltolylmethyl, trifluoromethylbenzyl, bis(trifluoromethyl)benzyl, propylbenzyl, tolylmethyl, fluorophenethyl, fluorenylmethyl, methoxyphenethyl, dimethoxybenzyl, dichlorophenethyl, phenylethylbenzyl, isopropylbenzyl, diphenylmethyl, propylbenzyl, butylbenzyl, dimethylethylbenzyl, phenylpentyl, tetramethylbenzyl, phenylhexyl, dipropylbenzyl, triethylbenzyl, cyclohexylbenzyl, naphthylmethyl, diphenylethyl, triphenylmethyl and hexamethylbenzyl.

As used herein, the term “divalent hydrocarbon radicals” refers to any straight chain, branched, cyclic, acyclic, heterocylic, saturated or unsaturated diradical, having the number of carbon atoms as indicated, comprising one or more hydrogen atoms. The term “divalent hydrocarbon radical” is intended to encompass the terms “alkanediyl”, “alkenediyl”, “alkynediyl”, “cycloalkanediyl”, “cycloalkenediyl”, “cycloalkynediyl”, “arylenediyl”, “aralkylenediyl” and “alkarylenediyl” as defined below.

The term “alkanediyl” refers to a straight or branched saturated divalent hydrocarbon radical having the number of carbon atoms indicated.

The terms “alkenediyl” and “alkynediyl” refer to straight or branched, unsaturated divalent hydrocarbon radicals. An “alkenediyl” is characterized by a carbon-carbon double bond and an “alkynediyl” is characterized by a carbon-carbon triple bond.

The term “cycloalkanediyl” refers to a cyclic saturated divalent hydrocarbon radical having the number of carbon atoms indicated.

The terms “cycloalkenediyl” and “cycloalkynediyl” refer to cyclic unsaturated divalent hydrocarbon radicals. A “cycloalkenediyl” is characterized by a carbon-carbon double bond and a “cycloalkynediyl” is characterized by a carbon-carbon triple bond.

The term “arylenediyl” refers to a divalent unsaturated aromatic carbocyclic radical having one or two rings.

The term “alkarylenediyl” refers to a divalent unsaturated mono- or di-alkyl-substituted aromatic carbocyclic radical having one or two rings. Binding is through the arylene group.

The term “aralkylenediyl” refers to a divalent unsaturated mono- or di-alkyl-substituted aromatic carbocyclic radical having one or two rings. Binding is through the alkylene group.

Reference to cyclic systems, e.g., cycloalkyl, aryl, heteroaryl, etc., contemplates monocyclic and polycyclic systems. Such systems comprise fused, nonfused and spiro conformations, such as bicyclooctyl, adamantyl, biphenyl and benzofuran.

As used herein, the term “heteroatom” includes N, O, S, P, Si and halogen (including F, Cl, Br and I).

The invention will now be described with reference to the following Examples. It will be appreciated that what follows is by way of example only and that modifications to detail may be made whilst still falling within the scope of the invention.

### EXAMPLES

The following antimicrobial compounds (L¹-X) are used in the following examples.

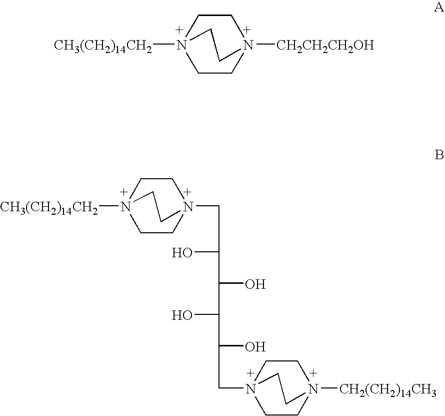

Preparation of Antimicrobial B: D-Mannitol (50.0 g, 0.27 mole) was dissolved in distilled water (10 L). To this was added sodium bicarbonate (45.37 g, 0.54 mole), followed by p-toluenesulfonyl chloride (102.95 g, 0.54 mole) were added. After one hour, DBC18Br (DABCO-C16, 201.45 g, 0.54 mole) was added. The reaction mixture was stirred for two days in the large scale reactor. 1-Butanol was added and the solvent was evaporated under reduced pressure. The resulting gel was dried under the hood for several days giving a white powder.

### Example 1

A 20% weight equivalent of the antimicrobial A is predissolved in methanol. 25 grams of Urepol was added to a flask with 3 grams of the 20% MeOH/antimicrobial slurry and stirred for 60 seconds with a high sheer and fast stirrer. This is left to stand for one minute. Than B-15J acrylate and water are added. Once all the materials are in solution, the mixture is stirred for 20 seconds. The resultant foam starts to rise in less than 20 seconds, and is poured onto release paper. This is left to stand for 24 hours to fully cure.

### Example 2

The same process as carried out in Example 1 is used except that the stirring of the Urepol and antimicrobial A is for 125 seconds.

### Example 3

In a flask, 25 grams of Urepol is stirred for 3 minutes. 3 grams of 25% weight equivalent antimicrobial A in methanol is added slowly and stirred for 60 seconds. The B-15J/water mixture is added (5.97 grams B-15J and 16 grams water) and stirred for 20 seconds. The resultant mixture is poured onto release paper and left to cure.

### Example 4

A 50% weight equivalent solution of antimicrobial A in methanol is prepared. 25 grams of Urepol (stirred for 180 seconds at extremely high speed) has 3 grams of the 50% antimicrobial A solution added thereto and is stirred for 60 seconds at high speed. This is left to stand for 20 seconds. Premixed B-15J and water (ratio 5.9 grams B-15J and 10 grams water) is added to the mixture over 3 seconds and is stirred for 30 seconds. This mixture is poured onto release paper and left to cure for 24 hours.

### Example 5

25 grams of Urepol is stirred for 180 seconds. 3.5 grams of 25% antimicrobial A in ethanol is added to the Urepol and is stirred for 3 minutes. 5.97 grams of B-15J and 16 grams of water are added thereto and the mixture is stirred for 25 seconds. The mixture is poured onto release paper and left to cure.

The following testing was carried out on the above compositions.

M3667—50% antimicrobial B foam.
M3600—50% antimicrobial A foam.
M3599—Hydropolymer foam—Negative Control

### Log₁₀ Reduction Testing

Testing was performed using Staphylococcus aureus NCTC 10788 and Pseudomonas aeruginosa NCIMB 10775, n=3 replicas.

| | Mean Log₁₀ Reductions | | | | | |
|---|---|---|---|---|---|---|
| | Staphylococcus aureus | | | Pseudomonas aeruginosa | | |
| | 60 | 120 | 180 | 60 | 120 | 180 |
| Test Sample | mins | mins | mins | mins | mins | mins |
| M3667 | 4.19 | >4.29 | >4.29 | 2.39 | 2.25 | 2.54 |
| M3600 | >4.29 | >4.29 | >4.29 | >4.16 | >4.16 | 4.03 |
| Hydropolymer | +0.15 | +0.43 | +0.73 | 0.14 | 0.39 | 0.40 |
| (M3599) | | | | | | |

>= no detectable survivors, starting inoculum 10⁵ cfu/ml, therefore only a 4.00 log₁₀ reduction could be generated (used to mimic critically colonised wounds).
+= instead of the numbers of microorganisms decreasing the actual numbers went up and an increase was seen indicating no antimicrobial effect

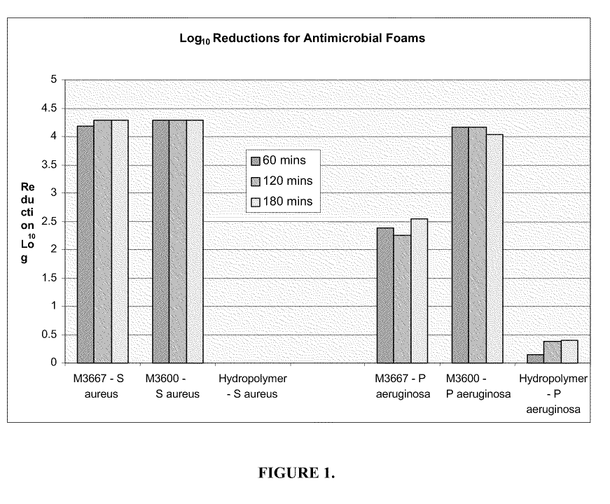

Both antimicrobials are active against S. aureus and P. aeruginosa. The M3600 is more effective than M3667 for both test microorganisms generating greater log₁₀ reductions (see FIG. 1).

The negative control caused a slight decrease in the numbers of P. aeruginosa cells over the 180 minute time period whereas for S. aureus an increase in the bacterial numbers were seen.

Both antimicrobials A and B have a C16 tail which has surprisingly been found to be effective against P. aeruginosa.

The C12 analogue of antimicrobials A and B is effective against P. aeruginosa.

1. An antimicrobial foamed polyurethane comprising at least one group X; wherein:
X comprises a group [R—([V^{m+}—R¹—R²] q[Y^{p-}])ₙ];
R is independently selected from divalent hydrocarbon radicals having 1-30 carbon atoms, optionally substituted on the carbon backbone with one or more groups selected from COOH, COO(C₁₋₆ alkyl), COO(C₆₋₂₀ aryl), halo, O(C₁₋₆ alkyl), O(C₆₋₂₀ aryl), O(C₇₋₂₀ alkaryl), O(C₇₋₂₀ aralkyl), ═O, NH₂, NO₂, CN and L;
L is selected from the group consisting of —OH, leaving group and mixtures thereof;
V comprises a positively charged moiety;
m represents an integer of 1-10;
n represents an integer of 1, 2, 3 or 4;
R¹ is independently selected from divalent hydrocarbon radicals having 1-30 carbon atoms;
R² is independently selected from the group consisting of —H, —CH₃, —SH, —F, —Cl, —Br, —I, —OR³—HN(O)CR⁴, or —O(O)CR⁵, wherein R³, R⁴ and R⁵ are independently selected from the group consisting of —H and monovalent hydrocarbon radicals having 1-30 carbon atoms;
Y represents an anion;
q represents m/p; and,
p represents an integer of 1-10.

2. An antimicrobial foamed polyurethane according to claim 1, wherein X is linked to the polyurethane via a carbon atom of the backbone of group R or via a substituent on the backbone of group R.

3. An antimicrobial foamed polyurethane according to claim 1, wherein R is selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ aralkylenediyl, C₇₋₃₀ alkarylenediyl and C₅₋₃₀ arylenediyl, any of which is optionally substituted on the carbon backbone with one or more groups selected from COOH, COO(C₁₋₆ alkyl), COO(C₆₋₁₀ aryl), halo, O(C₁₋₆ alkyl), O(C₆₋₁₀ aryl), O(C₇₋₁₀ alkaryl), O(C₇₋₁₀ aralkyl), ═O, NH₂, NO₂, CN and L.

4. An antimicrobial foamed polyurethane according to claim 1, wherein R is selected from methylene, 1,2-ethylene, 1,2-propylene, 1,3-propylene, 1,2-butylene, 1,3-butylene, 1,4-butylene, 1,5-pentylene, 1,6-hexylene, 1,8-octylene, 1,10-decylene and 1,12-dodecylene, any of which is optionally substituted on the carbon backbone with one or more groups selected from OH and leaving groups.

5. An antimicrobial foamed polyurethane according to claim 1, wherein R¹ is selected from the group consisting of C₁₋₃₀ alkanediyl, C₂₋₃₀ alkenediyl, C₂₋₃₀ alkynediyl, C₃₋₃₅ cycloalkanediyl, C₃₋₃₅ cycloalkenediyl, C₅₋₃₅ cycloalkynediyl, C₇₋₃₅ aralkylenediyl, C₇₋₃₅ alkarylenediyl and C₅₋₃₅ arylenediyl.

6. An antimicrobial foamed polyurethane according to claim 1, wherein R¹ is selected from the group consisting of a straight chain C₇ alkanediyl, C₈ alkanediyl, C₉ alkanediyl, C₁₀ alkanediyl, C₁₁ alkanediyl, C₁₂ alkanediyl, C₁₃ alkanediyl, C₁₄ alkanediyl, C₁₅ alkanediyl, C₁₆ alkanediyl and C₁₇ alkanediyl.

7. An antimicrobial foamed polyurethane according to claim 1, wherein R¹ is a —(CH₂)₁₅— group or a —(CH₂)₁₁— group.

8. An antimicrobial foamed polyurethane according to claim 1, wherein R² is —H or CH₃.

9. An antimicrobial foamed polyurethane according to claim 1, wherein n is 1.

10. An antimicrobial foamed polyurethane according to claim 1, wherein R³, R⁴ and R⁵ are independently selected from the group consisting of —H, C₁₋₂₀ alkyl, C₂₋₂₀ alkenyl, C₂₋₂₀ alkynyl, C₃₋₃₀ cycloalkyl, C₃₋₃₀ cycloalkenyl, C₄₋₃₀ cycloalkynyl, C₇₋₃₀ aralkyl, C₇₋₃₀ alkaryl, C₅₋₃₀ aryl, C₃₋₃₀ heteroaryl, and C₃₋₃₀ heterocyclyl.

11. An antimicrobial foamed polyurethane according to claim 1, wherein moiety V comprises a group (A): 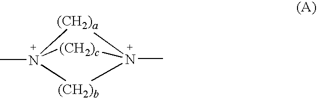
wherein a, b and c independently represent 1-10.

12. An antimicrobial foamed polyurethane according to claim 1, wherein n=1 and the —[R—([V^{m+}—R¹—R²] moiety comprises the structure (1): 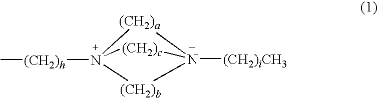
wherein h represents 1-10;
i represents 7-17; and
a, b, and c independently represent 1-10.

13. An antimicrobial foamed polyurethane according to claim 1, wherein n=1 and the —[R—([V^{m+}—R¹—R²] moiety has the structure (4):

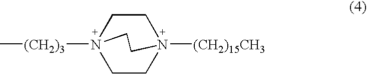

14. An antimicrobial foamed polyurethane according to claim 1, wherein n=2 and the —[R—([V^{m+}—R¹—R²] moiety has the structure (5): 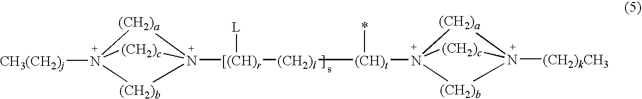
wherein (5) is attached to the polyurethane polymer via the —(CH)—* group;
j represents 1-17;
k represents 1-17;
r represents 0-10;
l represents 0-10;
s represents 0-10;
t represents 1;
L is selected from the group consisting of an OH group or a leaving group, or a mixture thereof; and
a, b, and c independently represent 1-10.

15. A method for the production of an antimicrobial foamed polyurethane comprising:
(i) mixing a C₁₋₃ alcohol solution comprising a compound having the formula L¹-X wherein:
X comprises a group —[R—([V^{m+}—R¹—R²] q[Y^{p-}])ₙ];
R is independently selected from divalent hydrocarbon radicals having 1-30 carbon atoms, optionally substituted on the carbon backbone with one or more groups selected from COOH, COO(C₁₋₆ alkyl), COO(C₆₋₂₀ aryl), halo, O(C₁₋₆ alkyl), O(C₆₋₂₀ aryl), O(C₇₋₂₀ alkaryl), O(C₇₋₂₀ aralkyl), ═O, NH₂, NO₂, CN and L;
V comprises a positively charged moiety;
m represents an integer of 1-10;
n represents an integer of 1, 2, 3 or 4;
R¹ is independently selected from divalent hydrocarbon radicals having 1-30 carbon atoms;
R² is independently selected from the group consisting of —H, —CH₃, —SH, —F, —Cl, —Br, —I, —OR³, —HN(O)CR⁴, or —O(O)CR⁵, wherein R³, R⁴ and R⁵ are independently selected from the group consisting of —H and monovalent hydrocarbon radicals having 1-30 carbon atoms;
Y represents an anion;
q represents m/p; and,
p represents an integer of 1-10; and,
L¹ is an —OH group or a leaving group;
L is selected from the group consisting of —OH, leaving group and mixtures thereof;
with an isocyanate-containing, polyurethane-forming prepolymer; and
(ii) adding an acrylate containing compound and water to the mixture of (i).

16. A method according to claim 15, wherein compounds having the formula L¹-X are selected from the group consisting of: 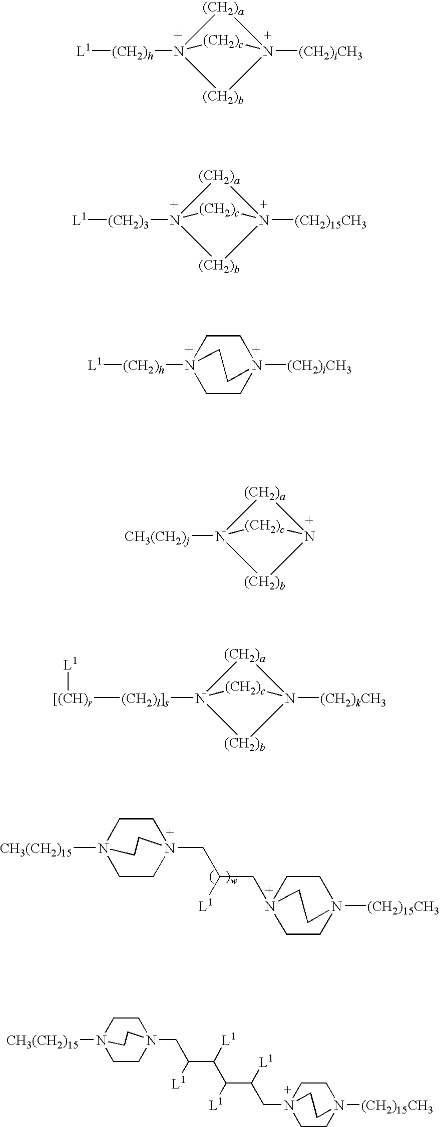
wherein h represents 1-10;
i represents 7-17;
j represents 1-17;
k represents 1-17;
r represents 0-10;
l represents 0-10;
s represents 0-10;
w is 1, 2, 3 or 4; and
a, b, and c independently represent 1-10.

17. A method according to claim 15, wherein the C₁₋₃ alcohol is selected from the group consisting of methanol, ethanol, 1-propanol, 2-propanol and mixtures thereof.

18. A method according to claim 15, wherein the ratio of the compound having the formula L¹-X to the C₁₋₃ alcohol is in the range of about 1:10 to about 2:1.

19. A method according to claim 15, wherein the compound L¹-X is added to the C₁₋₃ alcohol in an amount of 20%-50% by weight of the alcohol.

20. A method according to claim 15, wherein the solution of the compound having the formula L¹-X in the C₁₋₃ alcohol is added to the prepolymer in the ratio of about 1:20 to about 1:3 by weight.

21. A method according to claim 15, wherein the alcoholic solution of L¹-X is added to the prepolymer in an amount of 10%-20% by weight of the prepolymer.

22. A method according to claim 15, wherein the prepolymer used in step (i) of the present invention is a diisocyanate terminated oligomer selected from the group selected from diisocyanate terminated polyethylene oxide, diisocyanate terminated polypropylene oxide, diisocyanate terminated polyethylene oxide/polypropylene oxide copolymers, diisocyanate terminated polytetramethylene oxide, diisocyanate terminated polyisobutylene, diisocyanate terminated polyethylene adipate, diisocyanate terminated polycaprolactone and diisocyanate terminated polydimethylsiloxane.

23. A method according to claim 15, wherein the prepolymer is an diisocyanate-terminated polyether.

24. A method according to claim 15, wherein the ratio of the acrylate to water is in the range of about 1:5 to about 1:1 by weight.

25. A method according to claim 15, wherein acrylate compounds are selected from the group consisting of (meth)acrylic monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluoyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl)trimethoxysilane, trifluoromethylmethyl (meth)acrylate, 2-trifluoromethylethyl (meth)acrylate, 2-perfluoroethylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate and mixtures thereof.

26. A polyurethane foam obtainable by a method according to claim 15.

27. A pharmaceutical composition comprising an antimicrobial foamed polyurethane according to claim 1.

28. An article selected from clothing, footware inserts, bandages, sutures, protective gear and containers, comprising an antimicrobial foamed polyurethane obtainable by a method according to claim 15.

29. A medical device comprising an antimicrobial foamed polyurethane according to claim 1.

30. A medical device according to claim 29, wherein the device is a wound dressing.

31. A medical device according to claim 29, wherein the device further comprises a therapeutic agent.

32. A kit of parts, comprising:
(i) a C₁₋₃ alcohol;
(ii) a compound having the formula L¹-X;
(iii) an isocyanate-containing, polyurethane-forming prepolymer; and
(iv) an acrylate containing compound;
wherein components (i), (ii), (iii) and (iv) are as defined in claim 15.

33. A kit of parts according to claim 32, further comprising water.

34. (canceled)
